(19) United States
(12) Patent Application Publication
(10) Pub. No.: US 2004/0182940 A1
(43) Pub. Date: Sep. 23, 2004

(54) Electronic media disc assembly

(76) Inventor: Richard L. Biller, Deerfield, IL (US)

Correspondence Address: Marc D. Machtinger, Esq., Law Office of Marc D. Machtinger, Ltd., Suite 350, 750 W. Lake Cook Road, Buffalo Grove, IL, 60089, US

(21) Appl. No.: 10/393,112

(22) Filed: Mar. 20, 2003

(51) Int. Cl. G06K 19/06

(52) U.S. Cl. 235/493

(57) ABSTRACT

An electronic media disc assembly having an electronic media disc for point of purchase activation of an account associated with the disc is disclosed. In one embodiment, the disc is programmed to allow a user access to a global computer network for either a selected or predetermined duration. The internet use, or other access allowed by the disc, is preferably activated at the point of purchase. In another embodiment, the disc is an on-line gift card which either has a catalog stored on the disc or the disc directs the user to the seller's website. An account associated with the website or catalog is preferably activated at the point of purchase and the user may select items for purchase using the activated account. The electronic media disc has two surfaces, a base surface and a top surface. Preferably, the bottom surface has a data storage region while the top surface contains an encoded region. The encoded region is a magnetic stripe, a bar code, or other encoding. The encoded region on the disc can be scanned through a magnetic stripe reader with ease to activate the account associated with the disc. The disc is optionally affixed to a carrier with the encoded region on the carrier. Optionally, the disc or carrier has a display hole for hanging on a display rack.

### TECHNICAL FIELD

The present invention relates to an electronic media disc assembly, and more specifically to an electronic media disc having a data storage region and an encoded region for point of purchase activation of the disc.

### BACKGROUND OF THE INVENTION

Conventional media devices having information stored thereon are known and used in retail settings. For example, conventional gift cards are commonly sold in retail stores. The gift cards are generally wallet-sized cards with the retailer's logo on a face of the card. These gift cards contain a magnetic stripe which stores information for use of the card, such as the purchasing value of the card or locations where the card(s) may be used. The gift cards are usually purchased for a predetermined amount or may have a specific value added to the card. Conventionally, such gift cards do not have an integral means of enabling a purchaser to connect to the internet to use the gift card on a website associated with the source of the gift card.

Other conventional devices allow a consumer to purchase access to the internet using the disc. However, these devices have a number of components which have a high cost of manufacturing of the device. For example, U.S. Patent Publication No. 2002/0157974, discloses a main panel having a compact disc and a separate wallet-sized point of sale card attached to the panel. The CD is affixed to the main panel by shrinkwrap, adhesive, plastic insert, or other metal retainer. The point of sale card is affixed to the main panel by adhesive or shrinkwrap. The device, therefore, has greater manufacturing costs than a device containing point of sale information and other stored information on the same card because the cost of two separate components and the associated materials, such as the adhesive or shrinkwrap, is reduced.

Other conventional devices are capable of storing annular optical data and personal data on the same device, however, these devices do not provide point of sale activation of an account associated with the disc. The devices further do not contain computer readable instructions for enabling a purchaser to access the internet with the device. For example, U.S. Pat. No. 6,484,940, issued to Dilday et al., discloses a card having optical and magnetic data storage regions for use in consumer transactions. The card is designed for use in an ATM or other conventional magnetic swipe reading device. The optical data region allows much greater storage of user and account information than a card with only a magnetic stripe, and thus could contain much more information than a standard ATM or credit card with a magnetic stripe. However, the device does not enable point of sale activation of an account associated with the device. Also, the device does not enable the user to access to the internet with the device for a predetermined or selected duration of time.

Therefore, it would be advantageous to provide a single electronic media disc assembly comprising a data storage region and an encoded region which allows for point of purchase activation of an account associated with the disc, and which preferably enables the user to access a global computer network using the disc via an internet service provider.

### SUMMARY

In view of the deficiencies described above, it is an object of the present invention to provide a single electronic media disc assembly comprising a data storage region and an encoded region which allows for point of purchase activation of an account associated with the disc, and which preferably enables the user to access a global computer network using the disc via an internet service provider.

The present invention is an electronic media disc assembly. The disc has a top surface and a bottom surface. There is a data storage region disposed on the bottom surface and an encoded region on the top surface. The encoded region preferably stores simple account information, like a username and password, for enabling a point of sale activation of an account associated with the disc. In an alternate embodiment, the account may be activated by the user on a peripheral device of a computing system. The encoded region is preferably a magnetic strip, and is optionally a bar code or other suitable encoding means. The encoded region may be affixed to the bottom surface via an adhesive, a hot stamp, or the encoded region is optionally a component of an over-laminate on a multi-layer laminate.

Preferably, the data storage region is an annular optical storage region, but may be of any other suitable form of data storage which can store a large quantity of data.

Annular optical discs work by spinning the disc rapidly around a stationary assembly. Data is subsequently read through a beam of focused light off of concentric or spiral tracks embedded in the disc. The electronic media disc preferably has an aperture to engage the disc to a rotatable drive mechanism of a conventional optical data reader. The disc is typically a standard CD or DVD.

In one embodiment, the encoded region comprises identification information associated with the account such as a username or password. The identification information is preferably used at the point of sale to activate an account for the purchaser.

By activating the account, the purchaser can access the internet by using the disc and the account via an internet service provider. The duration of the access may be predetermined or is for a duration selected by the user at the time of purchase.

In another embodiment, the disc comprises computer-readable instructions to direct a user to an on-line catalogue. The user preferably purchases the disc and an account having a predetermined or selectable amount of credit toward purchase of a service or product. The account is preferably activated at the point of sale. Once at the user's on-line catalogue, the purchaser is able to select and purchase merchandise or services from the on-line catalogue internet site using the account associated with said disc. The catalogue can be a means of any form of sellable items, including products, services, software, music, or movie downloads.

In another embodiment, the disc has a catalogue stored thereon. The user preferably purchases the disc and an account having a predetermined amount of credit. The account is also preferably activated at the point of sale. The purchaser is able to select merchandise from the catalogue. The disc also has computer readable instructions for enabling communication of any selections and the account associated with the disc via the internet to a seller or provider of the selection via an internet service provider.

The disc has a top surface and a bottom surface. There is a data storage region disposed on the bottom surface and an encoded region on the top surface. Preferably, a magnetic stripe is either parallel to a flat bottom edge of the disc or is parallel to such an edge after tearing or breaking off a removable portion. This allows easy swiping of the disc through a standard magnetic stripe reading device. In one embodiment, the disc is substantially rounded but has a flat bottom edge and the encoded region is oriented substantially parallel to the bottom edge. This configuration allows for easy sliding and reading of the disc through a magnetic stripe reader. The disc optionally has a display hole for holding said disc on a display.

In yet another embodiment, the disc has two flat edges oriented substantially parallel to one another and also a flat bottom edge. There is an optional angled portion connecting each of said flat sides to the flat bottom portion. The encoded region is substantially parallel to the bottom edge.

In yet another embodiment, the disc has a flat bottom edge and the encoded region is oriented substantially parallel to the bottom edge. The embodiment also has a removable carrier adjoined to the bottom edge which has a display hole for holding the disc on a display. The removable portion is capable of being snapped or ripped off at the point of purchase.

In yet another embodiment, the disc assembly has a carrier that contains the encoded region. The encoded region is preferably a magnetic stripe. The disc is perforated or scored in such a manner that the carrier containing the magnetic stripe can be removed by tearing or snapping with ease at the point of sale.

In a further series of embodiments, the embodiments previously disclosed may be affixed to a carrier. The carrier may be cardstock, cardboard or ay other suitable material capable of holding a disc thereto. In one embodiment, a disc having a magnetic stripe parallel to the bottom edge of the disc is affixed to the carrier. The carrier has a scored edge along a length of the carrier such that a portion of the carrier can easily be folded back to enable the magnetic stripe to be swiped through a magnetic stripe reader, such as at a checkout counter, without obstruction.

In another embodiment, the disc having a magnetic stripe is affixed to the carrier such that the magnetic stripe extends beyond the bottom edge of the carrier. In this embodiment, the device may be readily swiped through a magnetic reader without obstruction of the carrier.

In another embodiment, the carrier has the magnetic stripe disposed on a surface of the carrier substrate which is perpendicular to the side walls of the carrier. A portion containing the magnetic stripe is adapted to be removed by tearing or breaking at the point of sale. Optionally, the carrier has a display hole for holding the device on a display rack.

A method for manufacturing the device of the present invention by providing the various components and steps described in detail below is also disclosed.

Other features and advantages of the invention will be apparent from the following detailed description taken in conjunction with the following drawings.

### BRIEF DESCRIPTION OF THE DRAWINGS

FIG. 1 is a top view of an embodiment of the present invention.

FIG. 2 is a top view of another embodiment of the present invention.

FIG. 3 is a top view of another embodiment of the present invention.

FIG. 4 is a top view of another embodiment of the present invention.

FIG. 5 is a top view of another embodiment of the present invention showing an electronic media disc affixed to a carrier.

FIG. 6 is a top view of another embodiment of the present invention.

FIG. 7 is a top view of another embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is an electronic media disc assembly 10. The assembly 10 includes an electronic media disc 20 having a top surface 30 and a bottom surface 40. There is a data storage region 50 disposed on the bottom surface 40 and an encoded region 60 on the top surface 30. The encoded region 60 stores data enabling a point of sale activation of an account associated with the disc 20. Point of sale activation can be effected by any suitable means, for example, by reading the encoded region 60 at a checkout counter on a device which effects communication of the information on the encoded region 60 to a remote central activation management center.

In an alternate embodiment, the account may be activated by the user on a peripheral device of a computing system. The encoded region 60 may be a magnetic stripe 70, a bar code or any other suitable encoding. The encoded region 60 is affixed to the bottom surface 40 via an adhesive, a hot stamp, or is optionally a component of an over-laminate on a multi-layer laminate.

The encoded region 60 preferably comprises identification information associated with an account created for the purchaser. The identification information is preferably used at the point of sale to activate the account. The identification information preferably is a username and password, but may be any other suitable means of allowing access to an account associated with the disc 20. Activation of the account preferably enables a purchaser to access a global computer network, such as the world wide web or “internet” using the disc and the account via a network service provider. The length of the use may be for a predetermined duration or may be of a length of time selectable by the purchaser at the time of purchase.

In one embodiment, the disc 20 comprises computer-readable instructions to direct a user to an on-line catalogue. Once viewing the on-line catalogue, the user is able to select and purchase merchandise or services from the on-line catalogue site using the account associated with said disc. Preferably, when the user obtains the disc 20 he or she also purchases a predetermined amount of credit associated with the account to apply toward purchase of the selected merchandise.

In another embodiment, the data storage region 50 of the disc 20 comprises a catalogue of products of merchandise. The catalogue is a means of any form of sellable items, including products, services, software, music, or movie downloads. In this embodiment, the user is able to select at least a selection of merchandise from the catalogue. The disc 20 contains computer readable instructions which enable the at least one selection and account information associated with the disc 20 to be communicated via a global computer network, such as the internet to the seller or a provider of the at least one selection. The user can apply a predetermined amount of credit associated with the account to such a purchase.

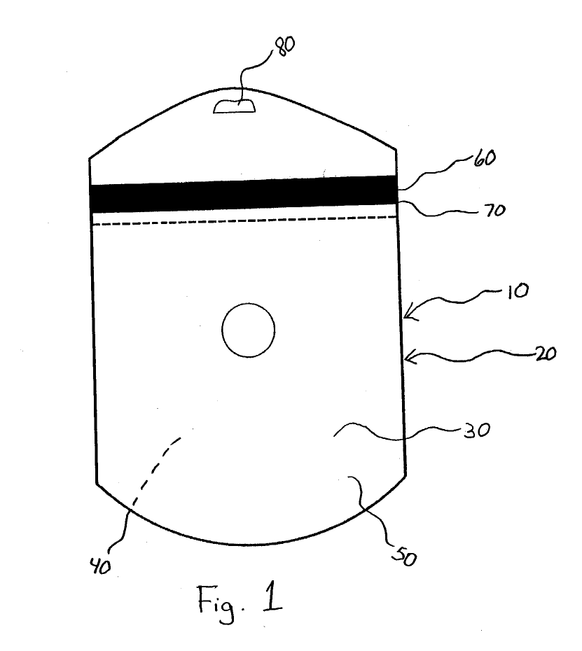

In one embodiment, the disc 20 has a carrier 100 as shown in FIG. 1. The carrier 100 is adjoined to the disc 20. The carrier 100 contains the encoded region 60 which is a magnetic stripe 70. A length of the carrier 100 is scored or perforated such that a portion of said carrier 100 containing the magnetic stripe 70 is separated at a point of sale. Optionally, the carrier 100 has a display hole 80 for holding the disc 20 on a display rack. The display hole 80 allows a retailer to attractively display the disc assembly 10 while allowing for easy swiping of the magnetic stripe 70 at the checkout to activate the account associated with the disc 20.

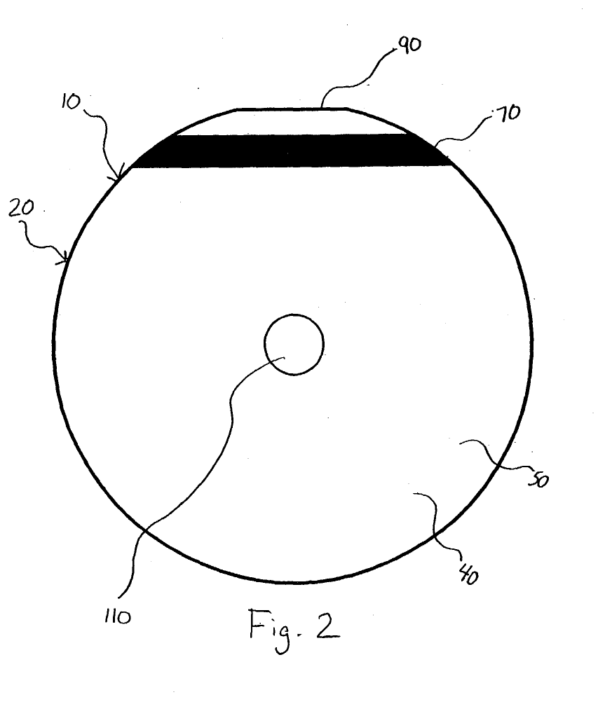

In another embodiment, as shown in FIG. 2, the disc 20 is substantially rounded with a flat bottom edge 90. Preferably, the encoded region 60 is a magnetic stripe 70 which is oriented substantially parallel to the flat bottom edge 90. Optionally, the disc 20 has an aperture 110 to engage the disc to rotatable drive mechanism of an optical data reader.

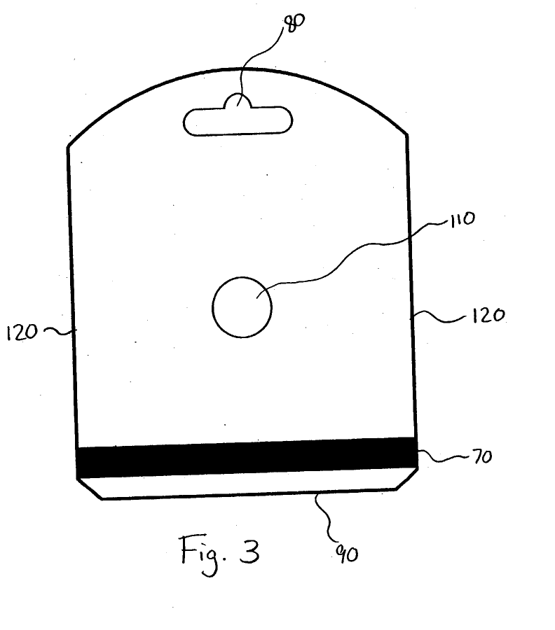

In another embodiment, as shown in FIG. 3, the disc 20 comprises two flat edges 120 oriented substantially parallel to one another and perpendicular to the flat bottom edge 90. The encoded region 60 is preferably a magnetic stripe 70. The magnetic stripe is oriented substantially parallel to the flat bottom edge 90. The disc 20 has a display hole 80 for holding the disc 20 on a display rack. Optionally, the disc 20 has an aperture 110 to engage the disc to a rotatable drive mechanism of an optical data reader.

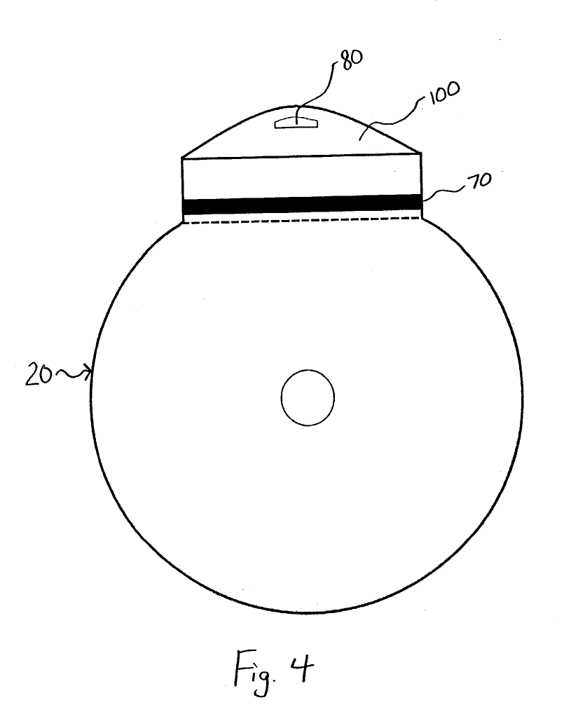

In yet another embodiment, as shown in FIG. 4, the disc 20 has a carrier 100 similar to the embodiment in FIG. 1. The carrier 100 is adjoined to the disc 20. The carrier 100 contains the encoded region 60 which is a magnetic stripe 70. A length of the carrier 100 is scored or perforated such that a portion of said carrier 100 containing the magnetic stripe 70 is separated at a point of sale. Optionally, the carrier 100 has a display hole 80 for holding the disc 20 on a display rack. The display hole 80 allows a retailer to attractively display the disc assembly 10 while allowing for easy swiping of the magnetic stripe 70 at the checkout to activate the account associated with the disc 20.

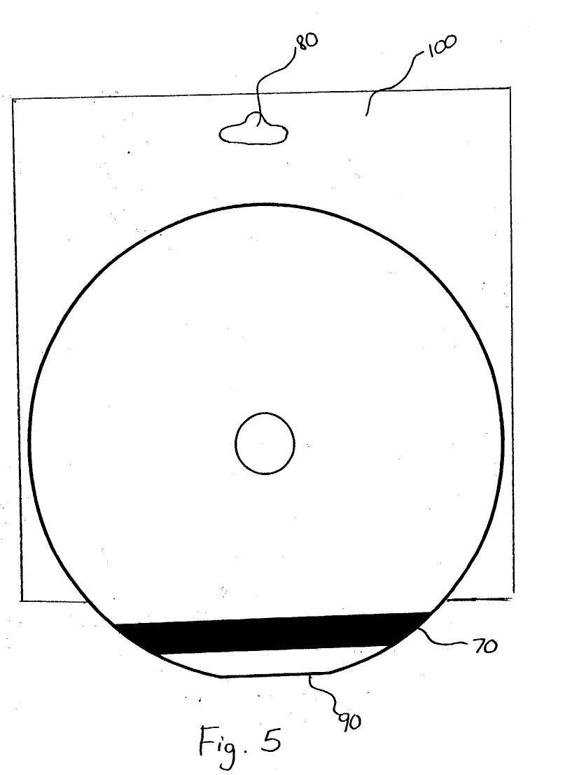

In another embodiment, as shown in FIG. 5, the disc 20 is affixed to a carrier 100. In this embodiment, the encoded region 60 is a magnetic stripe 70 which fully extends beyond a bottom plane of the carrier. Optionally, the carrier 100 has a display hole 80 for displaying the assembly 10 on a display rack. This embodiment renders it easy for a retailer to attractively display the disc assembly 10 while allowing for easy swiping of the magnetic stripe 70 at the checkout to activate the account associated with the disc 20.

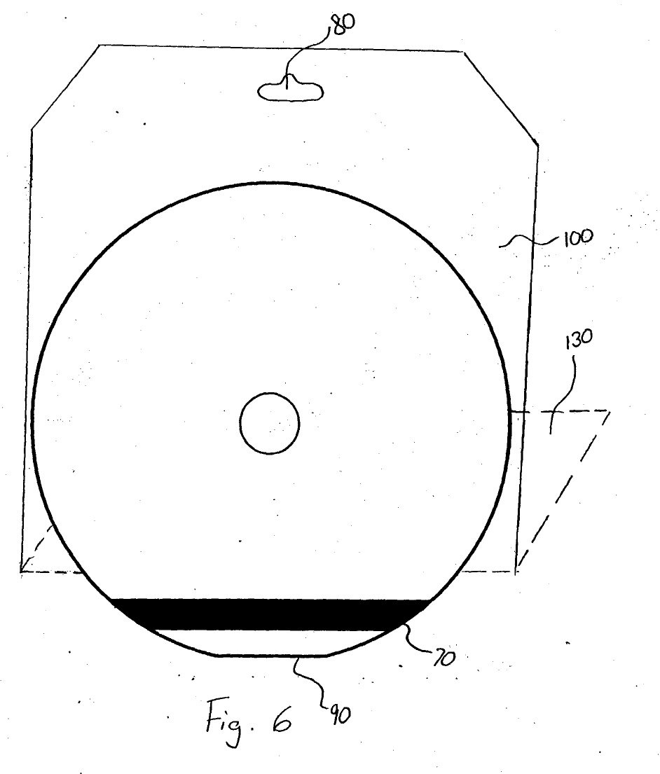

In yet another embodiment, as shown in FIG. 6, the disc 20 is affixed to a carrier 100. In this embodiment, the carrier 100 folds back along a length of the carrier 100 to form a folded region 130 such that enough space is created between said folded region 130 and said magnetic stripe 70. This embodiment allows the magnetic stripe 70 of the disc 20 to be swiped through a magnetic stripe reader without interference of the carrier 100.

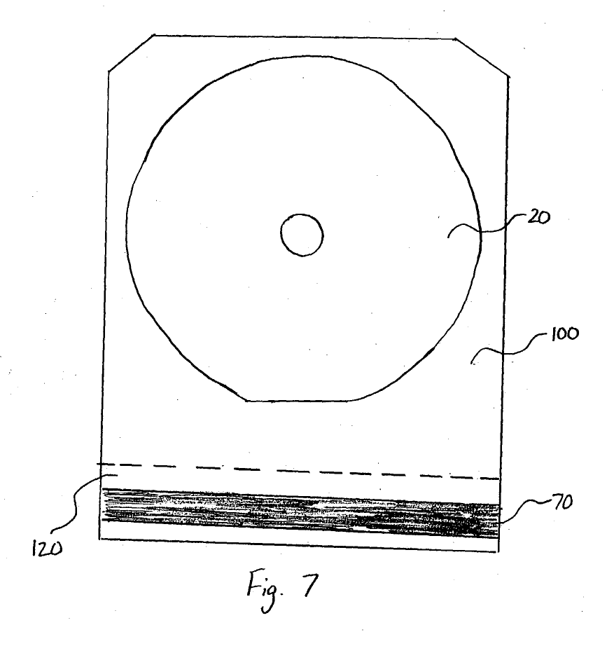

In yet another embodiment, as shown in FIG. 7, the disc 20 is affixed to a carrier 100. In this embodiment, the disc 20 is affixed to the carrier 100. The carrier 100 comprises the encoded portion 60 which is a magnetic stripe 70. The carrier 100 is scored or perforated along a length such that a removable portion 120 of the carrier could be removed by tearing or snapping at the point of sale.

As used herein, “disc” refers to any physical form of media which contains information related to an account such as a prepaid account, debit account, phone card, gift card, catalog, on-line catalog, internet access, etc. which is intended to be read in a rotatable disc drive.

While the specific embodiments have been illustrated and described, numerous modifications come to mind without significantly departing from the spirit of the invention, and the scope of protection is only limited by the scope of the accompanying claims.

What is claimed is:

1. An electronic media disc assembly, comprising:
an electronic media disc having a top surface and a bottom surface,
a data storage region disposed on the bottom surface, and
an encoded region on the top surface, wherein said encoded region stores data enabling a point of sale activation of an account associated with said disc.

2. The electronic media disc assembly according to claim 1, wherein said encoded region is a magnetic stripe.

3. The electronic media disc assembly according to claim 1, wherein said encoded region is a bar code.

4. The electronic media disc assembly according to claim 1, wherein said disc further comprises a display hole through an outer portion of said disc outside of said data storage region for holding said disc assembly on a display.

5. The electronic media disc assembly according to claim 1, wherein said encoded region comprises identification information associated with said account, wherein said identification information is used at the point of sale to activate said account, and wherein activation of said account enables a purchaser to access a global computer network using said disc and said account via a network service provider.

6. The electronic media disc assembly according to claim 5, wherein said account provides access to the global computer network for a predetermined duration.

7. The electronic media disc assembly according to claim 5, wherein said account provides access to the global computer network for a selectable duration which is selected by the purchaser at a time of purchase.

8. The electronic media disc assembly according to claim 1, wherein said disc comprises computer-readable instructions to direct a user to an on-line catalogue, and wherein such a user is able to select and purchase merchandise or services from the on-line catalogue site using said account associated with said disc.

9. The electronic media disc assembly according to claim 8, wherein said user can apply a predetermined amount of credit associated with said account to such a purchase.

10. The electronic media disc assembly according to claim 1, wherein said data storage region comprises a catalogue, and wherein a user is able to select at least a selection of merchandise from said catalogue, and wherein said disc enables communication of the at least one selection and said account associated with said disc via a global computer network to a seller or a provider of the at least one selection.

11. The electronic media disc assembly according to claim 10, wherein said user can apply a predetermined amount of credit associated with said account to such a purchase.

12. The electronic media disc assembly according to claim 1, wherein said encoded region is affixed to the top surface via an adhesive.

13. The electronic media according to claim 1, wherein said encoded region is affixed to the top surface via a hot stamp.

14. The electronic media disc assembly according to claim 1, wherein said encoded region is a component of an over-laminate on a multi-layer laminate.

15. The electronic media disc assembly according to claim 1, wherein said disc comprises a flat bottom edge, and wherein said encoded region is a magnetic stripe which is substantially parallel to said flat bottom edge.

16. The electronic media disc assembly according to claim 15, wherein said disc comprises two flat edges oriented substantially parallel to one another and perpendicular to said flat bottom edge.

17. The electronic media disc assembly according to claim 1, wherein said disc is affixed to a carrier, and wherein said encoded region is a magnetic stripe which fully extends beyond a bottom plane of said carrier.

18. The electronic media disc assembly according to claim 1, wherein said encoded region is a magnetic stripe, and wherein said disc is affixed to a carrier, and wherein said carrier folds back along a length of said carrier to form a folded region such that enough space is created between said folded region and said magnetic stripe wherein said magnetic stripe of said disc can be swiped through a magnetic stripe reader without interference of the carrier.

19. The electronic media disc assembly according to claim 18, wherein said carrier comprises a display hole for holding said disc assembly on a display rack.

20. An electronic media disc assembly, comprising:
a carrier,
an electronic media disc having a top surface and a bottom surface affixed to said carrier,
a data storage region disposed on the bottom surface,
an encoded region for enabling a point of sale activation of an account associated with said disc disposed on said carrier, and wherein a length of said carrier is scored or perforated such that a portion of said carrier containing the encoded region is separated at a point of sale.

21. The electronic media disc assembly according to claim 20, wherein said carrier comprises a display hole for holding said disc assembly on a display rack.

22. An electronic media disc assembly, comprising:
an electronic media disc having a top surface and a bottom surface,
a data storage region disposed on the bottom surface, and
an encoded region on the top surface, wherein said encoded region stores data enabling a activation by a peripheral device at a computer of a user.

23. A method for providing account activation associated with an electronic media disc assembly, comprising:
providing an electronic media disc having a top surface and a bottom surface,
disposing a data storage region on the bottom surface,
providing an encoded region on the top surface, and
activating said account at a point of sale of the disc using said encoded region.

24. The method according to claim 23, wherein said encoded region is a magnetic stripe.

25. The method according to claim 23, wherein said encoded region is a bar code.

26. The method according to claim 23, wherein said disc further comprises a display hole through an outer portion of said disc outside of said data storage region for holding said disc assembly on a display.

27. The method according to claim 23, wherein said encoded region comprises identification information associated with said account, wherein said identification information is used at the point of sale to activate said account, and wherein activation of said account enables a purchaser to access a global computer network using said disc and said account via a network service provider.

28. The method according to claim 27, wherein said account provides access to the global computer network for a predetermined duration.

29. The method according to claim 27, wherein said account provides access to the global computer network for a selectable duration which is selected by the purchaser at a time of purchase.

30. The method according to claim 23, wherein said disc comprises computer-readable instructions to direct a user to an on-line catalogue, and wherein such a user is able to select and purchase merchandise or services from the on-line catalogue site using said account associated with said disc.

31. The method according to claim 30, wherein said user can apply a predetermined amount of credit associated with said account to such a purchase.

32. The method according to claim 23, wherein said data storage region comprises a catalog, and wherein a user is able to select at least one selection of merchandise from the catalog, and wherein said disc enables communication of the at least one selection and said account associated with said disc via the internet to a seller or provider of the selection.

33. The method according to claim 32, wherein said user can apply a predetermined amount of credit associated with said account to such a purchase.

34. The method according to claim 23, wherein said encoded region is affixed to the top surface via an adhesive.

35. The electronic media according to claim 23, wherein said encoded region is affixed to the top surface via a hot stamp.

36. The method according to claim 23, wherein said encoded region is a component of an over-laminate on a multi-layer laminate.

37. The method according to claim 23, wherein said disc comprises a flat bottom edge, and wherein said encoded region is a magnetic stripe which is substantially parallel to said flat bottom edge.

38. The method according to claim 38, wherein said disc comprises two flat edges oriented substantially parallel to one another and perpendicular to said flat bottom edge.

39. The method according to claim 23, wherein said disc is affixed to a carrier, and wherein said encoded region is a magnetic stripe which fully overhangs a bottom plane of said carrier.

40. The method according to claim 23, wherein said encoded region is a magnetic stripe, and wherein said disc is affixed to a carrier, and wherein said carrier folds back along a length of said carrier to form a folded region such that enough space is created between said folded region and said magnetic stripe wherein said magnetic stripe of said disc can be swiped through a magnetic stripe reader without interference of said carrier.

41. The method according to claim 40, wherein said carrier comprises a display hole for holding said disc assembly on a display rack.

42. A method for providing account activation associated with an electronic media disc assembly, comprising:
providing a carrier,
affixing an electronic media disc having a top surface and a bottom surface to said carrier,
disposing a data storage region on the bottom surface, and
providing an encoded region on the top surface for enabling a point of sale activation of an account associated with said disc disposed on said carrier, and wherein a length of said carrier is scored or perforated such that a portion of said carrier containing the encoded region is separated at a point of sale.

43. The method according to claim 42, wherein said carrier further comprises a display hole on said carrier for holding said disc assembly on a display.

44. A method for providing account activation associated with an electronic media disc, comprising:
disposing a data storage region the bottom surface, and
providing an encoded region on the top surface, wherein said encoded region stores data enabling a activation by a peripheral device at a computer of a user.
